(19) United States
(12) Patent Application Publication
(10) Pub. No.: US 2026/0056149 A1
(43) Pub. Date: Feb. 26, 2026

(54) Device For Facilitating The Imaging Of Biological Entities

(71) Applicant: Wisconsin Alumni Research Foundation, Madison, WI (US)

(72) Inventors: Elizabeth Wright, Madison, WI (US); Nicholas Rienstra, Madison, WI (US); Steve Garvis, Madison, WI (US); Juan Sanchez, Madison, WI (US)

(21) Appl. No.: 18/814,828

(22) Filed: Aug. 26, 2024

(51) Int. Cl. G01N 23/2204; B01L 3/00; G01N 23/2251

(52) U.S. Cl. CPC G01N 23/2204; B01L 3/502715; G01N 23/2251; B01L 2300/0681; B01L 2300/0816; G01N 2223/418; G01N 2223/612

(57) ABSTRACT

A device is provided for facilitating the imaging of biological entities. The device includes a body having upper and lower surfaces. The body defines a channel for accommodating fluid flow therethrough and a well communicating with the channel and the lower surface. A microscopy grid is removably received in the body and has a first side communicating with the channel and a second side directed at well. A retainer extends into the channel and is engageable with the microscopy grid to support the microscopy grid.

### REFERENCE TO GOVERNMENT GRANT

This invention was made with government support under GM104540 and GM139168 awarded by the National Institutes of Health and under DE-SC0018409 awarded by the US Department of Energy. The government has certain rights in the invention.

### FIELD OF THE INVENTION

The present invention relates generally to the imaging of biological entities, and in particular, to a device that allows for the live-cell imaging of biological entities in a liquid environment that mimics their native environment and allows for the biological entities to be preserved in place for cryogenic electron microscopy imaging and downstream data processing and analysis.

### BACKGROUND AND SUMMARY OF THE INVENTION

The most common approach for studying dynamic cellular events is light microscopy. Typically, in light microscopy, biological entities (e.g., cells, organoids, tissue) are affixed to a slide or coverslip. A bright light source illuminates the biological entities and a resulting image is formed by the contrast between the biological entities and their surroundings. It can be appreciated that beyond the mere observation of biological entities, light microscopy may also be utilized to capture live-cell images in a liquid environment which mimics their native environment. While functional for its intended purpose, the resolution of the images utilizing light microscopy is somewhat limited.

Cryogenic electron microscopy (cryo-EM) and cryogenic electron tomography (cryo-ET) are imaging techniques wherein the three-dimensional (3D) structure of biological molecules, complexes, and intact cells are illustrated at high- to atomic resolutions. In this technique, an aqueous solution of the biological sample is applied to a grid/mesh and is rapidly cooled in liquid ethane or a mixture of liquid ethane and propane to cryogenic temperatures, e.g., below −150° Celsius (C), so as to preserve the biological sample in an environment of vitreous ice. An electron microscope is used to image the biological sample while it is held at cryogenic temperatures. In single particle cryo-EM, a set of thousands of two-dimensional (2D) images of nearly identical objects are captured by a camera. For cryo-ET, uniquely shaped biological entities are examined by the collection of individual tilt-series that are composed of 2D images acquired over a range of angles. In both approaches, advanced computational algorithms are then used to reconstruct 3D maps and models of the biological sample from the collected 2D images.

Cryogenic electron microscopy (cryo-EM) continues to grow in popularity, largely due to the near-atomic resolution of samples, including biological specimens. Improvements in sample preparation and reconstruction software are driving an uptake in usage of cryo-EM in many applications and industries, including pharma. However, cryo-EM is still limited in certain applications, particularly those where dynamic native conditions have an immense impact on behavior and sample development (e.g., bacterial biofilm formation, generation of organoids, and cellular expansion). As a result, researchers are pursuing complimentary technology for cryo-EM sample preparation that could marry improvements in cell culture (e.g., flow cells) with reliable/repeatable electron microscopy (EM) sample grid preparation.

In view of the foregoing, it can be appreciated that it would highly desirable to provide a device that utilizes an electron microscopy (EM) substrate which is held in place during the seeding of biological entities (cells, organoids, tissue), allows for the growth and expansion of the biological entities to be followed by live-cell imaging (in a liquid environment that mimics their native environment), and allows for the biological entities to be preserved in place for cryogenic electron microscopy imaging and downstream data processing and analysis.

Therefore, it is primary object and feature of the present invention to provide a device that allows for the live-cell imaging of biological entities in a liquid environment that mimics their native environment and allows for the biological entities to be preserved in place for cryogenic electron microscopy imaging and downstream data processing and analysis.

It is a further object and feature of the present invention to provide a device for facilitating the imaging of biological entities that utilizes an electron microscopy (EM) substrate which is held in place during the seeding of biological entities (cells, organoids, tissue).

It is a still further object and feature of the present invention to provide a device for facilitating the imaging of biological entities that is simple to utilize and inexpensive to manufacture.

In accordance with the present invention, a device is provided for facilitating the imaging of biological entities. The device includes a body having upper and lower surfaces. The body defines a channel for accommodating fluid flow therethrough and a well communicating with the channel and the lower surface. A microscopy grid is removably received in the body and has a first side communicating with a channel and a second side directed at well. A retainer extends into the channel and is engageable with the microscopy grid to support the microscopy grid. The channel includes an inlet and an outlet at opposite ends thereof.

A transparent coverslip is attached to the lower surface of the body and overlaps the well. In addition, the body includes a grid aperture extending between the channel and the well and being axially aligned with the channel. The grid aperture has a diameter and the well has a diameter. The diameter of the grid aperture is less than the diameter of the well. The grid aperture is generally circular and has outer periphery. The grid aperture includes first and second enlarged portions projecting radially from opposite sides thereof. The first enlarged portion of the grid aperture extends toward the inlet of the channel and the second enlarged portion is directed at the outlet.

The body may be defined by an upper portion and a lower portion. The channel extends between the upper and lower portions of the body. A sealing gasket is positioned between the upper and lower portions of the body. The sealing gasket extends about the channel. The lower portion of the body includes an upper surface. The upper surface includes a portion partially defining the channel. The portion of the lower surface includes a first ramp having a first end spaced from the inlet of the channel and a second end adjacent the microscopy grid and a second ramp having a first end spaced from the outlet of the channel and a second end adjacent the microscopy grid. A wall projects into the channel adjacent the inlet. The wall is configured to generate turbulence in fluid flowing through the channel.

In accordance with a further aspect of the present invention, a device is provided for facilitating the imaging of biological entities. The device includes a body defined by upper and lower portions. The upper portion has a lower surface that includes a portion partially defining a channel. The lower portion has an upper surface that includes a portion partially defining the channel. A well extends through the lower portion and communicates with the channel. A grid has a first side communicating with the channel and a second side directed at well. A retainer extends from the lower surface into the channel and is engageable with the grid to support the grid. A coverslip is attached to a lower surface of a lower portion and overlaps the well.

The channel includes an inlet and an outlet and the lower portion of includes a grid aperture extending between the channel and the well. The grid aperture has a diameter and the well has a diameter. The diameter of the grid aperture is less than the diameter of the well. The grid aperture is generally circular and has outer periphery. In addition, the grid aperture includes first and second enlarged portions projecting radially from opposite sides thereof. The first enlarged portion of the grid aperture extends toward the inlet of the channel and the second enlarged portion is directed at the outlet.

The portion of the upper surface of the lower portion includes a first ramp having a first end spaced from the inlet of the channel and a second end intersecting the first enlarged portion of the grid aperture and a second ramp having a first end spaced from the outlet of the channel and a second end intersecting the second enlarged portion of the grid aperture. A sealing gasket is positioned between the upper and lower portions of the body and extends about the channel. A wall projects into the channel. The wall is configured to generate turbulence in fluid flowing through the channel. A clamp is removably engageable with the upper and lower portions of the body. The clamp maintains the upper surface of the lower portion against the lower surface of the upper portion.

In accordance with a still further aspect of the present invention, a device is provided for facilitating the imaging of biological entities. The device includes a body defined by upper and lower portions. The upper portion has a lower surface including a portion partially defining a channel having an input end and an output end. The lower portion has an upper surface including a portion partially defining the channel. A well extends through the lower portion and a grid aperture extends between the channel and the well. The gird aperture has a diameter less than the diameter of the well. A grid is removably received in the grid aperture. The grid has a first side communicating with the channel and a second side directed at well. A coverslip is attached to a lower surface of the lower portion and overlaps the well. A retainer extends from the lower surface of the upper portion into the channel and is engageable with the grid, the retainer retaining the grid against the coverslip.

The grid aperture is generally circular and has outer periphery. The grid aperture includes first and second enlarged portions projecting radially from opposite sides thereof. The first enlarged portion of the grid aperture extends toward the inlet of the channel and the second enlarged portion is directed at the outlet. The portion of the upper surface of the lower portion includes a first ramp having a first end spaced from the inlet of the channel and a second end intersecting the first enlarged portion of the grid aperture and a second ramp having a first end spaced from the outlet of the channel and a second end intersecting the second enlarged portion of the grid aperture. A sealing gasket is positioned between the upper and lower portions of the body. The sealing gasket extends about the channel. A wall projects into the channel. The wall is configured to generate turbulence in fluid flowing through the channel. The retainer is engageable with an outer periphery of the grid. The retainer may be first retainer and may also include a second retainer extending from the lower surface of the upper portion into the channel and being engageable with the grid. The first and second retainers have a generally crescent-shaped configuration and are circumferentially spaced from each other.

### BRIEF DESCRIPTION OF THE DRAWINGS

The drawings furnished herewith illustrate a preferred methodology of the present invention in which the above advantages and features are clearly disclosed as well as others which will be readily understood from the following description of the illustrated embodiment.

In the drawings:

FIG. 1 is an isometric view of a microfluidic device in accordance with the present invention;

FIG. 2 is an exploded view of the microfluidic device of FIG. 1;

FIG. 2A is a top plan view of a lower portion of the microfluidic device of FIG. 1;

FIG. 3 is a top plan view of an alternate configuration of the lower portion of the microfluidic device shown in FIG. 2A;

FIG. 4 is a cross-sectional view of the lower portion of the microfluidic device of the present invention taken along line 4-4 of FIG. 3;

FIG. 5 is a bottom plan view of an upper portion of the microfluidic device of FIG. 1;

FIG. 6 is a cross-sectional view of the upper portion of the microfluidic device of the present invention taken along line 6-6 of FIG. 5;

FIG. 7 is a cross-sectional view of the microfluidic device of the present invention taken along line 7-7 of FIG. 1;

FIG. 8 is a cross-sectional view of the microfluidic device of the present invention taken along line 8-8 of FIG. 7;

FIG. 9 is a cross-sectional view, similar to FIG. 7, showing the microfluidic device of the present invention in operation; and

FIG. 10 is an isometric view showing a part of the upper portion of the microfluidic device of the present invention.

### DETAILED DESCRIPTION OF THE DRAWINGS

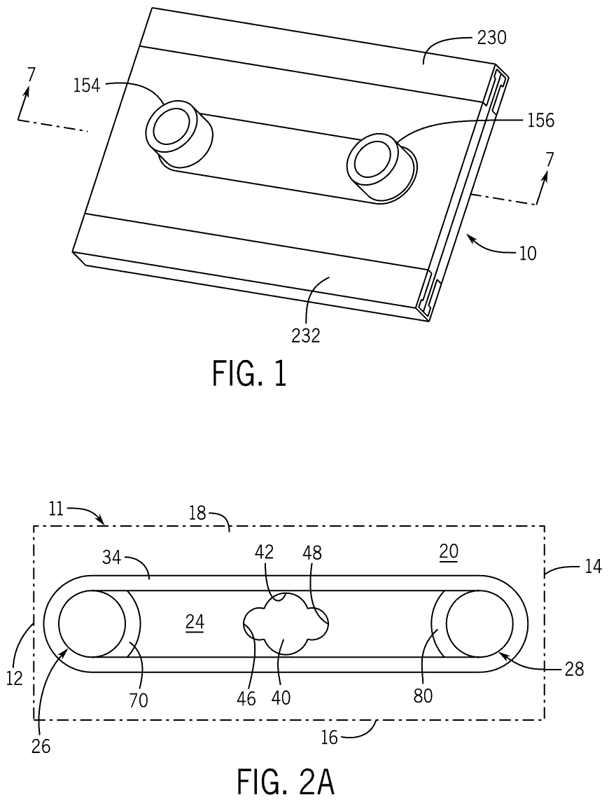

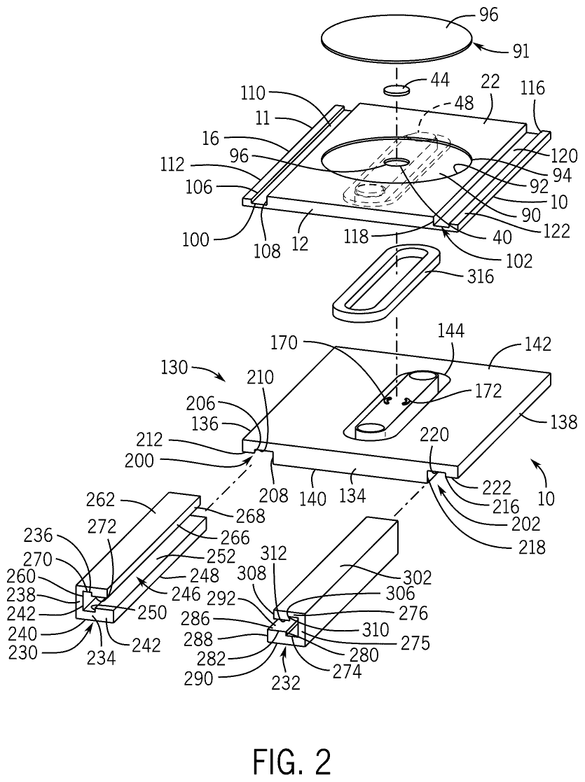

Referring to FIGS. 1-2, a microfluidic device in accordance with the present invention is generally designated by the reference numeral 10. Microfluidic device 10 may be formed from a photopolymer resin, however, other materials are contemplated as being within the scope of the present invention. As best seen in FIGS. 2-4, in the depicted embodiment, microfluidic device 10 includes lower portion 11 having first and second ends 12 and 14, respectively; first and second sides 16 and 18, respectively; and upper and lower surfaces 20 and 22, respectively. It is contemplated for microfluidic device 10 to have dimensions generally equal to the dimensions of a standard-sized light microscopy slide. Recessed surface 24 is provided in upper surface 20 of lower portion 11 of microfluidic device 10 and extends along axis. Recessed surface 24 includes a first input end 26 and a second output end 28 and has an outer edge 32 extending about the outer periphery thereof.

Referring to FIG. 2A, grid receipt aperture 40 extends through recessed surface 24 and is defined by generally cylindrical sidewall 42. Grid receipt aperture 40 has diameter less than the width of recessed surface 24 and has a sufficient dimension to accommodate grid 44, as hereinafter described. Grid receipt aperture 40 further includes first and second enlarged portions 46 and 48, respectively, extending toward corresponding input end 26 and output end 28, respectively. First and second enlarged portions 46 and 48, respectively, of grid receipt aperture 40 have generally crescent-shapes to allow grid 44 to be grasped by a pair of tweezers or the like.

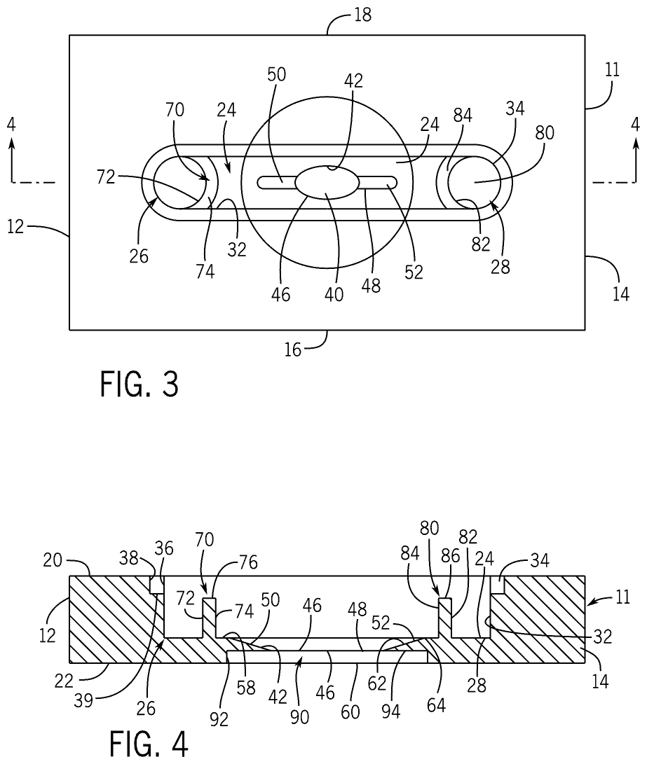

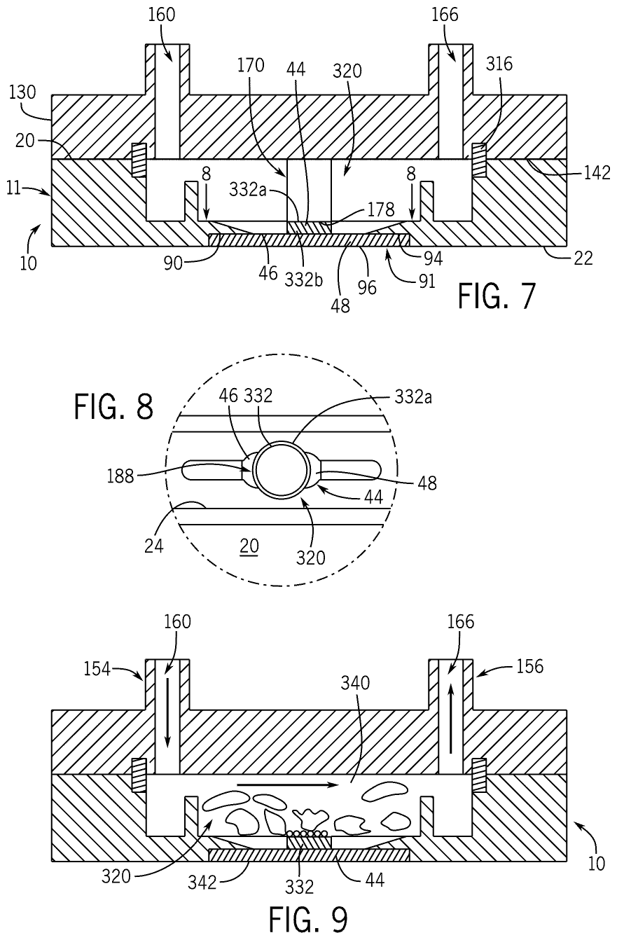

As best seen in FIGS. 3-4 and 7-8, in an alternate configuration, ramps 50 and 52 may be provided in recessed surface 24 to further facilitate the grasping of grid 44 with a pair of tweezers or the like. Ramp 50 includes angled surface 56 has a first end 58 intersecting recessed surface 24 at a location spaced from first input end 26 of recessed surface 24 and a second end 60 communicating with first enlarged portion 46 of grid receipt aperture 40. Ramp 52 includes angled surface 62 has a first end 64 intersecting recessed surface 24 at a location spaced from second output end 28 of recessed surface 24 and a second end 66 communicating with second enlarged portion 48 of grid receipt aperture 40.

Referring to FIGS. 2A-4 and 7-8. seal receiving channel 34 extends about outer edge 32 of recessed surface 24 and is defined by a first inner wall 36 depending from outer edge 32 and an outer wall 38 spaced from inner wall 36 by lower surface 39. Lower surface 39 is generally parallel to upper surface 20 of lower portion 11 of microfluidic device 10 and perpendicular to inner and outer walls 36 and 38, respectively.

First arcuate wall 70 extends from recessed surface 24 at between first input end 26 of recessed surface 24 and first end 58 of angled surface 56 of ramp 50, if present. First arcuate wall 70 is defined by a generally arcuate first side 72 directed towards first input end 26 of recessed surface 24 and a generally arcuate second side 74 directed away from first input end 26 of recessed surface 24. First and second sides 72 and 74, respectively, are interconnected by upper surface 76 lying in a plane vertically spaced from upper surface 20 of lower portion 11 of microfluidic device 10, for reasons hereinafter described.

Second arcuate wall 80 extends from recessed surface 24 at a location between second output end 28 of recessed surface 24 and first end 64 of angled surface 62 of ramp 52, if present. Second arcuate wall 80 is defined by a generally arcuate first side 82 directed towards second output end 28 of recessed surface 24 and a generally arcuate second side 84 directed away from second output end 28 of recessed surface 24. First and second sides 82 and 84, respectively, are interconnected by upper surface 86 lying in a plane vertically spaced from upper surface 20 of lower portion 11 of microfluidic device 10, for reasons hereinafter described.

As best seen in FIGS. 2 and 4, lower surface 22 of lower portion 11 of microfluidic device 10 includes a coverslip well 90 formed therein. Coverslip well 90 is defined by generally cylindrical surface 92 projecting from the outer periphery of a generally ring-shaped ledge 94. Ledge 94 has an outer diameter generally equal to the outer diameter of a generally circular, transparent coverslip 91 and an inner diameter greater than the diameter of grid 44. As described, ledge 94 is adapted for receiving coverslip 91 thereon, as hereinafter described. Ledge 94 is spaced from lower surface 22 of lower portion 11 of microfluidic device 10 by a distance generally equal to the thickness of coverslip 91, such that outer face 96 of coverslip 91 is substantially flush with lower surface 22 of lower portion 11 of microfluidic device 10 with coverslip 91 received on ledge 94.

Lower surface 22 of lower portion 11 of microfluidic device 10 further includes first and second, generally parallel grooves 100 and 102, respectively, therein. First groove 100 extends between first and second ends 12 and 14, respectively, of lower portion 11 adjacent first side 16 thereof. First groove 100 is defined by first and second generally parallel sidewalls 106 and 108, respectively, interconnected by flat surface 110. Sidewall 106 is interconnected to first side 16 of lower portion 11 by planar surface 112, which lies in a plane spaced from and parallel to lower surface 22 of lower portion 11. Sidewall 108 intersects lower surface 22 of lower portion 11. Surface 110 lies in a plane spaced from and parallel to lower surface 22 of lower portion 11.

First groove 100 extends between first and second ends 12 and 14, respectively, of lower portion 11 adjacent first side 16 thereof. First groove 100 is defined by first and second generally parallel sidewalls 106 and 108, respectively, interconnected by flat surface 110. First sidewall 106 is interconnected to first side 16 of lower portion 11 by planar surface 112, which lies in a plane spaced from and parallel to lower surface 22 of lower portion 11. First sidewall 108 intersects lower surface 22 of lower portion 11. Surface 110 lies in a plane spaced from and parallel to lower surface 22 of lower portion 11.

Second groove 102 extends between first and second ends 12 and 14, respectively, of lower portion 11 adjacent second side 18 thereof. Second groove 102 is defined by first and second generally parallel sidewalls 116 and 118, respectively, interconnected by flat surface 120. First sidewall 116 is interconnected to second side 18 of lower portion 11 by planar surface 122, which lies in a plane spaced from and parallel to lower surface 22 of lower portion 11. Second sidewall 118 intersects lower surface 22 of lower portion 11. Surface 120 lies in a plane spaced from and parallel to lower surface 22 of lower portion 11.

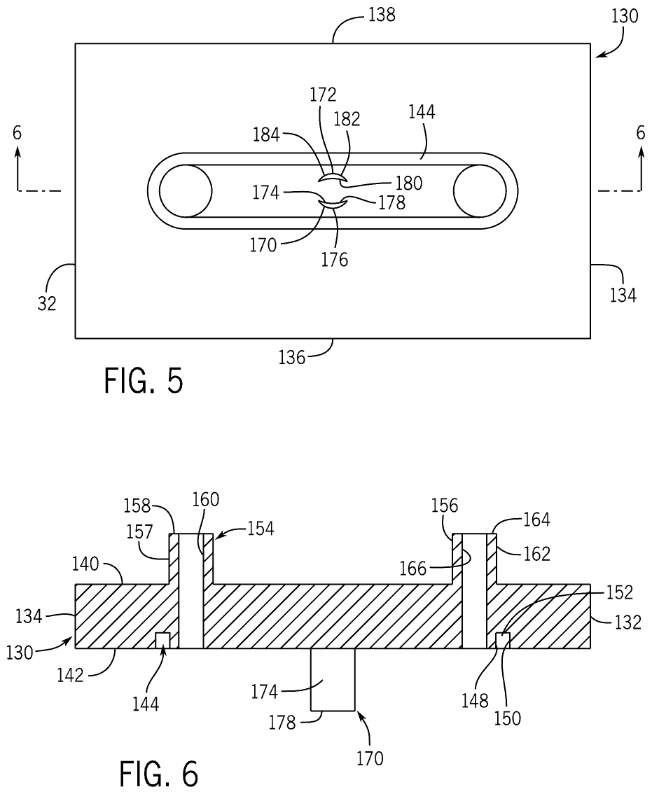

Referring to FIGS. 2 and 5-6, microfluidic device 10 further includes an upper portion 130 having first and second ends 132 and 134, respectively; first and second sides 136 and 138, respectively; and upper and lower surfaces 140 and 142, respectively. Seal receiving channel 144 is formed in lower surface 142 and is defined by a first inner wall 148 and an outer wall 150 spaced from inner wall 148 by upper surface 152. Upper surface 152 is generally parallel to lower surface 142 of upper portion 130 of microfluidic device 10 and perpendicular to inner and outer walls 148 and 150, respectively. As described, it is intended for seal receiving channel 144 to corresponding in size, shape and dimension to seal receiving channel 34 in lower portion 11 of microfluidic device 10.

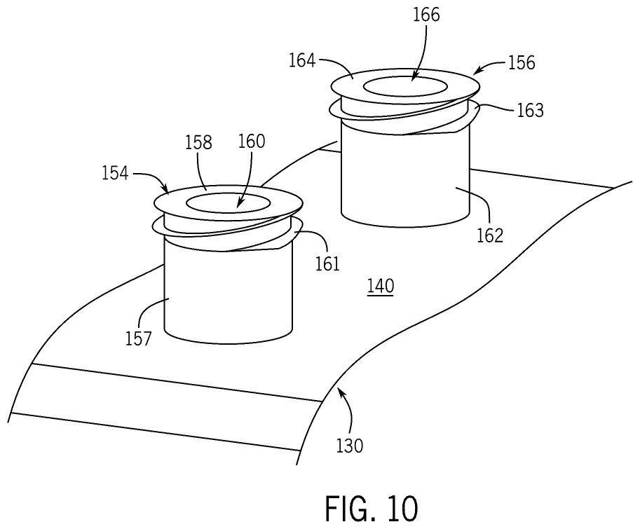

Upper portion 130 of microfluidic device 10 further includes an input port 154 and an output port 156 projecting from upper surface 140 thereof. Input port 154 is defined by a cylindrical outer surface 157 and a terminal surface 158 spaced from and parallel to upper surface 140. Passageway 160 extends axially from terminal surface 158 through input port 154 and upper portion 130 to lower surface 142 of upper portion 130 such that passageway 160 communicates with lower surface 142 of upper portion 130 at a location within seal receiving channel 144. As best seen in FIG. 10, it is contemplated to provide threading 161 on outer surface 157 of input port 154 to facilitate the connection of input port 154 to a source of cell culture media utilizing a standard leur lock connector.

Referring back to FIGS. 2 and 5-6, output port 156 is defined by a cylindrical outer surface 162 and a terminal surface 164 spaced from and parallel to upper surface 140. Passageway 166 extends axially from terminal surface 164 through output port 156 and upper portion 130 to lower surface 142 of upper portion 130 such that passageway 166 communicates with lower surface 142 of upper portion 130 at a location within seal receiving channel 144. It is contemplated to provide threading 163 on outer surface 162 of output port 156 to facilitate the connection of output port 156 to an output for cell culture media utilizing a standard leur lock connector, FIG. 10.

First and second crescent-shaped retainers 170 and 172, respectively, depending from lower surface 142 of upper portion 130. First retainer 170 is defined generally arcuate first side 174 directed towards second retainer 172 and a generally arcuate second side 176 directed away from second retainer 172. First and second sides 174 and 176, respectively, are interconnected by engagement surface 178 lying in a plane vertically spaced from lower surface 142 of upper portion 130. Second retainer 172 is defined generally arcuate first side 180 directed towards first retainer 170 and a generally arcuate second side 182 directed away from first retainer 170. First and second sides 180 and 182, respectively, are interconnected by engagement surface 184 lying in a common plane with engagement surface 178 of first retainer 170. As described, the distance between second sides 176 and 182 of first and second retainers 170 and 172, respectively, is generally equal to the outer diameter of grid 44 such that engagement surfaces 178 and 184 of first and second retainers 170 and 172, respectively, are engageable with outer rim 188 of grid 44, as hereinafter described.

Upper surface 140 of upper portion 130 of microfluidic device 10 further includes first and second, generally parallel grooves 200 and 202, respectively, therein. First groove 200 extends between first and second ends 132 and 134, respectively, of upper portion 130 adjacent first side 136 thereof. First groove 200 is defined by first and second generally parallel sidewalls 206 and 208, respectively, interconnected by flat surface 210. Sidewall 206 is interconnected to first side 136 of upper portion 130 by planar surface 212, which lies in a plane spaced from and parallel to upper surface 140 of upper portion 130. Sidewall 208 intersects upper surface 140 of upper portion 130. Surface 210 lies in a plane spaced from and parallel to upper surface 140 of upper portion 130.

Second groove 202 extends between first and second ends 132 and 134, respectively, of upper portion 130 adjacent second side 138 thereof. Second groove 202 is defined by first and second generally parallel sidewalls 216 and 218, respectively, interconnected by flat surface 220. First sidewall 216 is interconnected to second side 138 of upper portion 130 by planar surface 222, which lies in a plane spaced from and parallel to upper surface 140 of upper portion 130. Second sidewall 218 intersects upper surface 140 of upper portion 130. Surface 222 lies in a plane spaced from and parallel to upper surface 140 of upper portion 130.

Microfluidic device 10 further includes first and second generally C-shaped clamps 230 and 232, respectively, are provided. First clamp 230 extends along an axis and is defined by generally parallel, upper and lower spaced walls 234 and 236, respectively, interconnected and spaced by sidewall 238. Upper wall 234 includes a planar upper surface 240 and a lower surface 242 spaced from and parallel to upper surface 240. First key 246, having a generally rectangular configuration, depends from lower surface 242 and is defined by generally parallel first and second sides 248 and 250, respectively, interconnected by generally planar, terminal surface 252. For reasons hereinafter described, it is intended for first key 246 to form a mating relationship with first groove 200 in upper surface 140 of upper portion 130 of microfluidic device 10.

Lower wall 236 of first clamp 230 includes an upper surface 260 and a generally planar, lower surface 262 spaced from and parallel to upper surface 260. Second key 266, having a generally rectangular configuration, extends from upper surface 260 and is defined by generally parallel first and second sides 268 and 270, respectively, interconnected by generally planar, terminal surface 272. For reasons hereinafter described, it is intended for second key 266 to form a mating relationship with first groove 100 in upper surface 20 of lower portion 11 of microfluidic device 10.

Second clamp 232 extends along an axis and is defined by generally parallel, upper and lower spaced walls 274 and 276, respectively, interconnected and spaced by sidewall 278. Upper wall 274 includes a planar upper surface 280 and a lower surface 282 spaced from and parallel to upper surface 280. First key 286, having a generally rectangular configuration, depends from lower surface 282 and is defined by generally parallel first and second sides 288 and 290, respectively, interconnected by generally planar, terminal surface 292. For reasons hereinafter described, it is intended for first key 286 to form a mating relationship with second groove 202 in upper surface 140 of upper portion 130 of microfluidic device 10.

Lower wall 276 of second clamp 232 includes an upper surface 300 and a generally planar, lower surface 302 spaced from and parallel to upper surface 300. Second key 306, having a generally rectangular configuration, extends from upper surface 300 and is defined by generally parallel first and second sides 308 and 310, respectively, interconnected by generally planar, terminal surface 312. For reasons hereinafter described, it is intended for second key 306 to form a mating relationship with first groove 102 in lower surface 22 of lower portion 11 of microfluidic device 10.

Referring to FIGS. 2 and 7-8, in order to assemble microfluidic device 10, seal or gasket 316 is positioned in seal receiving channel 144 is formed in lower surface 142 of upper portion 130 of microfluidic device 10. Thereafter, upper surface 20 of lower portion 11 of microfluidic device 10 is positioned on lower surface 146 of upper portion 130 of microfluidic device 10 such that first and second ends 12 and 14, respectively, of lower portion 13 are aligned with and lie in common planes with corresponding first and second ends 132 and 134, respectively, of upper portion 130 and first and second sides 16 and 18, respectively, lower portion 11 are aligned with and lie in common planes with corresponding first and second sides 136 and 138, respectively, of upper portion 130. With lower portion 11 positioned on upper portion 130, seal 316 is received in seal receiving channel 34 in upper surface 20 of lower portion 11 and first and second retainers 170 and 172, respectively, are received in grid receipt aperture 40.

After positioning lower portion 11 on upper portion 130, as heretofore described, first and second clamps 230 and 232, respectively, are interconnected to lower portion 11 and upper portion 130 to retain lower portion 11 and upper portion 130 together. More specifically, first clamp 230 is positioned adjacent to either first end 12 of lower portion 11 and first end 132 of upper portion 130 or second end 14 of lower portion 11 and second send 134 of upper portion 130 such that first key 246 is axially aligned with first groove 200 in upper surface 140 of upper portion 130 and second key 266 is axially aligned with first groove 100 in lower surface 22 of lower portion 11. Thereafter, first clamp 230 is slid axially such the first key 246 is received within first groove 200 in upper surface 140 of upper portion 130 and second key 266 is received within first groove 100 in lower surface 22 of lower portion 11.

Similarly, second clamp 232 is positioned adjacent to either first end 12 of lower portion 11 and first end 132 of upper portion 130 or second end 14 of lower portion 11 and second end 134 of upper portion 130 such that first key 286 is axially aligned with second groove 202 in upper surface 140 of upper portion 130 and second key 306 is axially aligned with second groove 102 in lower surface 22 of lower portion 11.

Thereafter, second clamp 232 is slid axially such the first key 286 is received within second groove 202 in upper surface 140 of upper portion 130 and second key 306 is received within second groove 102 in lower surface 22 of lower portion 11.

With first and second clamps 230 and 232, respectively, securing upper portions 130 and lower portion 11 together, channel 320 is formed between upper portions 130 and lower portion 11. Channel 320 is defined by lower surface 142 in upper portion 130 and recessed surface 24 in lower portion 11 and includes a first end 322 in communication with passageway 160 through input port 154 and a second end 324 in communication with passageway 166 through output port 156. First and second clamps 230 and 232, respectively, act to compress seal 316 with seal receiving channels 34 and 144 such that seal 316 in seal receiving channels 34 and 144 retains fluid flowing in channel 320 and prevents leakage therefrom.

First and second arcuate walls 70 and 80, respectively, project into channel 320 such that upper surfaces 76 and 86 of first and second arcuate walls 70 and 80, respectively, are vertically spaced from lower surface 142 of upper portion 130. It is intended for first and second arcuate walls 70 and 80, respectively, to generate turbulence in fluid flowing through channel 320.

Tweezers or the like (not shown) may be used to deposit grid 44 on first and second retainers 170 and 172, respectively, such that outer rim 188 of grid 44 is supported on engagement surfaces 178 and 184 of first and second retainers 170 and 172, respectively, first side 332a of central grid portion 332 of grid 44 is communication with channel 320, and second side 332b of central grid portion 332 of grid 44 is directed towards and in communication with coverslip well 90. Once grid 44 is positioned on first and second retainers 170 and 172, respectively, coverslip 91 is positioned within coverslip well 90 such that the radially outer portion of upper surface 314 of coverslip 91 is positioned on ledge 94. The radially outer portion of upper surface 314 of coverslip 91 is bonded to ledge 94 is a conventional manner, e.g., by utilizing an ultraviolet bonding resin. Once coverslip 91 is bonded to ledge 94, outer surface 96 of coverslip 91 is substantially flush with lower surface 22 of lower portion 11 of microfluidic device 10. Thereafter, microfluidic device 10 may be flipped such that upper surface 140 of upper portion 130 of microfluidic device 10 is directed upwardly.

With microfluidic device assembled, it is contemplated to load channel 320 with a biological sample, e.g. a cell culture media 340. More specifically, cell culture media 340 is introduced into passageway 160 of input port 154 and flows into channel 320 wherein cells 342 in cell culture media 340 are allowed to incubate and attach to grid portion 332 of grid 44. As noted above, grid portion 332 of grid 44 is communication with channel 320. Cell culture media 340 may be replenished during incubation to maintain cell culture hydration during. Thereafter, minimal media flow may be continued to provide a liquid environment that mimics the cells' native environment, while preserving cells 340 for subsequent analysis.

It can be appreciated that during the incubation and growth of cells 340 on grid portion 188 of grid 44, microfluidic device 10 may be positioned on a stage of a light microscope, thereby allowing for long term live imaging of cells 340 in channel 320 through coverslip 91. As previously noted, microfluidic device 10 has dimensions generally equal to the dimensions of a standard-sized light microscopy slide, thereby enhancing the compatibility of microfluidic device 10 with the stage of the light microscope. Further, it can be understood grid 44 may be removed from microfluidic device 10 for facilitating imaging of cells 340 by an electron microscope. More specifically, in order to remove grid 44 from microfluidic device 10, first and second clamps 230 and 232, respectively, may be removed from upper and lower portions 140 and 11, respectively, thereby allowing lower portion 11 to be separated from upper portion 140. With lower portion 11 separated from upper portion 140, a user may use tweezers or the like (not shown) to remove grid 44 from first and second retainers 170 and 172, respectively. Thereafter, grid 44 may be frozen via plunge or high pressure freezing and imaged in a cryo-transmission electron microscope in a conventional manner.

Various modes of carrying out the invention are contemplated as being within the scope of the following claims particularly pointing out and distinctly claiming the subject matter, which is regarded as the invention.

We claim:

1. A device for facilitating the imaging of biological entities, comprising:
a body including upper and lower surfaces, the body defining a channel for accommodating fluid flow therethrough and a well communicating with the channel and the lower surface;
a microscopy grid removably received in the body and having a first side communicating with the channel and a second side directed away from the channel; and
a retainer extending into the channel and being engageable with the microscopy grid to support the microscopy grid;
wherein:
the channel includes an inlet and an outlet at opposite ends thereof.

2. The device of claim 1 further comprising a transparent coverslip attached to the lower surface of the body and overlapping the well.

3. The device of claim 2 wherein the body includes a grid aperture extending between the channel and the well and being axially aligned with the channel.

4. The device of claim 3 wherein the grid aperture has a diameter and the well has a diameter, the diameter of the grid aperture is less than the diameter of the well.

5. The device of claim 3 wherein the grid aperture is generally circular and has outer periphery, the grid aperture includes first and second enlarged portions projecting radially from opposite sides thereof.

6. The device of claim 5 wherein first enlarged portion of the grid aperture extends toward the inlet of the channel and the second enlarged portion is directed at the outlet.

7. The device of claim 1 wherein the body is defined by an upper portion and a lower portion, the channel extending between the upper and lower portions of the body.

8. The device of claim 7 further comprising a sealing gasket positioned between the upper and lower portions of the body, the sealing gasket extending about the channel.

9. The device of claim 7 wherein:
the lower portion of the body includes an upper surface, the upper surface including a portion partially defining the channel;
the portion of the lower surface including a first ramp having a first end spaced from the inlet of the channel and a second end adjacent the microscopy grid and a second ramp having a first end spaced from the outlet of the channel and a second end adjacent the microscopy grid.

10. The device of claim 1 further comprising a wall projecting into the channel adjacent the inlet, the wall configured to generate turbulence in fluid flowing through the channel.

11. A device for facilitating the imaging of biological entities, comprising:
a body defined by:
an upper portion having a lower surface, the lower surface including a portion partially defining a channel;
a lower portion having an upper surface, the upper surface including a portion partially defining the channel; and
a well extending through the lower portion and communicating with the channel;
a grid having a first side communicating with the channel and a second side directed at well;
a retainer extending from the lower surface into the channel and being engageable with the grid to support the grid; and
a coverslip attached to a lower surface of a lower portion and overlapping the well.

12. The device of claim 11 wherein the channel includes an inlet and an outlet and wherein the lower portion includes a grid aperture extending between the channel and the well.

13. The device of claim 12 wherein the grid aperture has a diameter and the well has a diameter, the diameter of the grid aperture is less than the diameter of the well.

14. The device of claim 12 wherein:
the grid aperture is generally circular and has outer periphery;
the grid aperture includes first and second enlarged portions projecting radially from opposite sides thereof; and
the first enlarged portion of the grid aperture extends toward the inlet of the channel and the second enlarged portion is directed at the outlet.

15. The device of claim 14 wherein the portion of the upper surface of the lower portion includes a first ramp having a first end spaced from the inlet of the channel and a second end intersecting the first enlarged portion of the grid aperture and a second ramp having a first end spaced from the outlet of the channel and a second end intersecting the second enlarged portion of the grid aperture.

16. The device of claim 11 further comprising a sealing gasket positioned between the upper and lower portions of the body, the sealing gasket extending about the channel.

17. The device of claim 11 further comprising a wall projecting into the channel, the wall configured to generate turbulence in fluid flowing through the channel.

18. The device of claim 11 further comprising a clamp removably engageable with the upper and lower portions of the body, the clamp maintaining the upper surface of the lower portion against the lower surface of the upper portion.

19. The device for facilitating the imaging of biological entities, comprising:
a body defined by:
an upper portion having a lower surface, the lower surface including a portion partially defining a channel having an input end and an output end;
a lower portion having an upper surface, the upper surface including a portion partially defining the channel;
a well extending through the lower portion;
a grid aperture extending between the channel and the well, the gird aperture having a diameter less than the diameter of the well;
a grid removably received in the grid aperture, the grid having a first side communicating with the channel and a second side directed at well;
a coverslip attached to a lower surface of the lower portion and overlapping the well;
a retainer extending from the lower surface of the upper portion into the channel and being engageable with the grid, the retainer retaining the grid against the coverslip.

20. The device of claim 18 wherein the grid aperture is generally circular and has outer periphery;
the grid aperture includes first and second enlarged portions projecting radially from opposite sides thereof; and
the first enlarged portion of the grid aperture extends toward the inlet of the channel and the second enlarged portion is directed at the outlet.

21. The device of claim 20 wherein the portion of the upper surface of the lower portion includes a first ramp having a first end spaced from the inlet of the channel and a second end intersecting the first enlarged portion of the grid aperture and a second ramp having a first end spaced from the outlet of the channel and a second end intersecting the second enlarged portion of the grid aperture.

22. The device of claim 19 further comprising a sealing gasket positioned between the upper and lower portions of the body, the sealing gasket extending about the channel.

23. The device of claim 19 further comprising a wall projecting into the channel, the wall configured to generate turbulence in fluid flowing through the channel.

24. The device of claim 19 wherein the retainer is engageable with an outer periphery of the grid.

25. The device of claim 19 wherein the retainer is first retainer and wherein the device further comprises:
a second retainer extending from the lower surface of the upper portion into the channel and being engageable with the grid, the first and second retainers have a generally crescent-shaped configuration and are circumferentially spaced from each other.
